(19) United States
(12) Patent Application Publication
(10) Pub. No.: US 2008/0084505 A1
(43) Pub. Date: Apr. 10, 2008

(54) DUST REMOVAL APPARATUS OF PHOTOGRAPHING APPARATUS

(75) Inventor: Yukio UENAKA, Tokyo (JP)

Correspondence Address: GREENBLUM & BERNSTEIN, P.L.C., 1950 ROLAND CLARKE PLACE, RESTON, VA, 20191, US

(73) Assignee: c/o PENTAX Corporation, Tokyo (JP)

(21) Appl. No.: 11/869,030

(22) Filed: Oct. 9, 2007

(30) Foreign Application Priority Data
Oct. 10, 2006 (JP) 2006-276872

(51) Int. Cl. H04N 5/00

(52) U.S. Cl. 348/616

(57) ABSTRACT

A dust removal apparatus of a photographing apparatus comprises a movable unit, a detector, and a controller. The movable unit has an imaging device and is movable. The detector is used for specifying a holding position of the photographing apparatus in relationship to the direction of gravity. The controller moves the movable unit on a plane that is parallel to a first direction and a second direction. The first direction is perpendicular to an optical axis of a photographing optical system that captures an optical image on a photographing surface of the imaging device. The second direction is perpendicular to the optical axis. The controller strikes the movable unit against a boundary of a range of movement of the movable unit in one of the first direction and the second direction, on the basis of the holding position, as a dust removal operation.

### BACKGROUND OF THE INVENTION

1. Field of the Invention

The present invention relates to a dust removal apparatus of a photographing apparatus, and in particular to restrain damage to the mechanism caused by the dust removal operation.

2. Description of the Related Art

A dust removal apparatus of a photographing apparatus, that removes the dust on the imaging device and the cover such as the low-pass filter, is proposed.

Japanese unexamined patent publication (KOKAI) No. 2005-340988 discloses a dust removal apparatus that strikes the movable unit including the imaging device against the boundary of the range of movement of the movable unit so that the shock of impact will remove the dust on the imaging device and the cover etc.

However, the direction of movement of the movable unit for the dust removal operation does not change with respect to the holding position of the photographing apparatus.

### SUMMARY OF THE INVENTION

Therefore, an object of the present invention is to provide a dust removal apparatus that controls the direction of movement of the movable unit for the dust removal operation with respect to the holding position of the photographing apparatus.

According to the present invention, a dust removal apparatus of a photographing apparatus comprises a movable unit, a detector, and a controller. The movable unit has an imaging device and is movable. The detector is used for specifying a holding position of the photographing apparatus in relationship to the direction of gravity. The controller moves the movable unit on a plane that is parallel to a first direction and a second direction. The first direction is perpendicular to an optical axis of a photographing optical system that captures an optical image on a photographing surface of the imaging device. The second direction is perpendicular to the optical axis. The controller strikes the movable unit against a boundary of a range of movement of the movable unit in one of the first direction and the second direction, on the basis of the holding position, as a dust removal operation.

### BRIEF DESCRIPTION OF THE DRAWINGS

The objects and advantages of the present invention will be better understood from the following description, with reference to the accompanying drawings in which:

FIG. 1 is a rearview perspective of the embodiment of the photographing apparatus viewed from the back side;

FIG. 2 is a front view of the photographing apparatus;

FIG. 3 is a circuit construction diagram of the photographing apparatus;

FIG. 4 is a flowchart that shows the main operation of the photographing apparatus;

FIG. 5 is a flowchart that shows the detail of the interruption process of the timer;

FIG. 6 is a figure that shows the calculations of the anti-shake operation;

FIG. 7 is a flowchart that shows the dust removal operation;

FIG. 8 is a graph that shows the relationship between an elapsed time and the position of the movable unit in the second direction in the dust removal operation;

FIG. 9 is a graph that shows the relationship between an elapsed time and the position of the movable unit in the first direction in the dust removal operation; and

FIG. 10 is a flowchart that shows the detail of driving the movable unit for the dust removal operation.

### DESCRIPTION OF THE PREFERRED EMBODIMENTS

The present invention is described below with reference to the embodiment shown in the drawings. In the embodiment, the photographing apparatus 1 is a digital camera. A photographing optical system, such as a camera lens 67 etc., that captures (images) an optical image on a photographing surface of the imaging device of the photographing apparatus 1 has an optical axis LX.

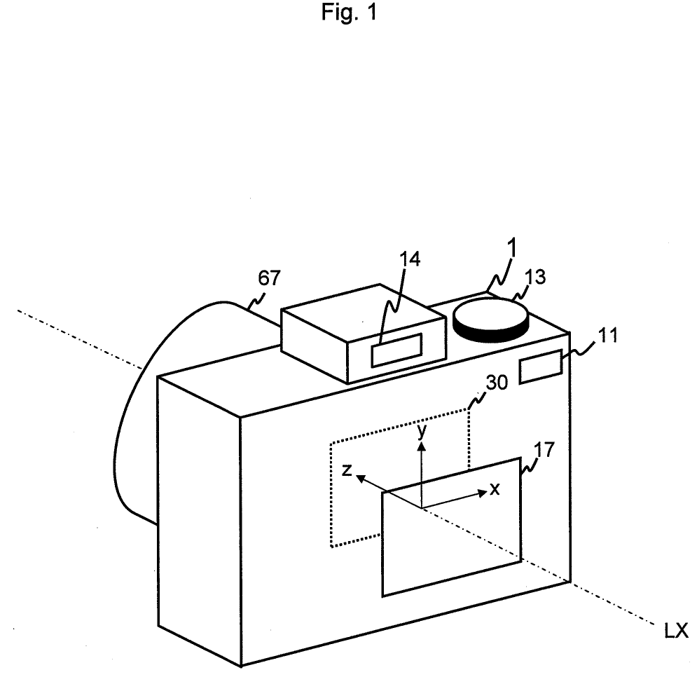

In order to explain the orientation of the embodiment, a first direction x, a second direction y, and a third direction z are defined (see FIG. 1). The first direction x is perpendicular to the optical axis LX. The second direction y is perpendicular to the optical axis LX and the first direction x. The third direction z is parallel to the optical axis LX and perpendicular to both the first direction x and the second direction y.

However, in the embodiment, the first direction x may not be perpendicular to the second direction y.

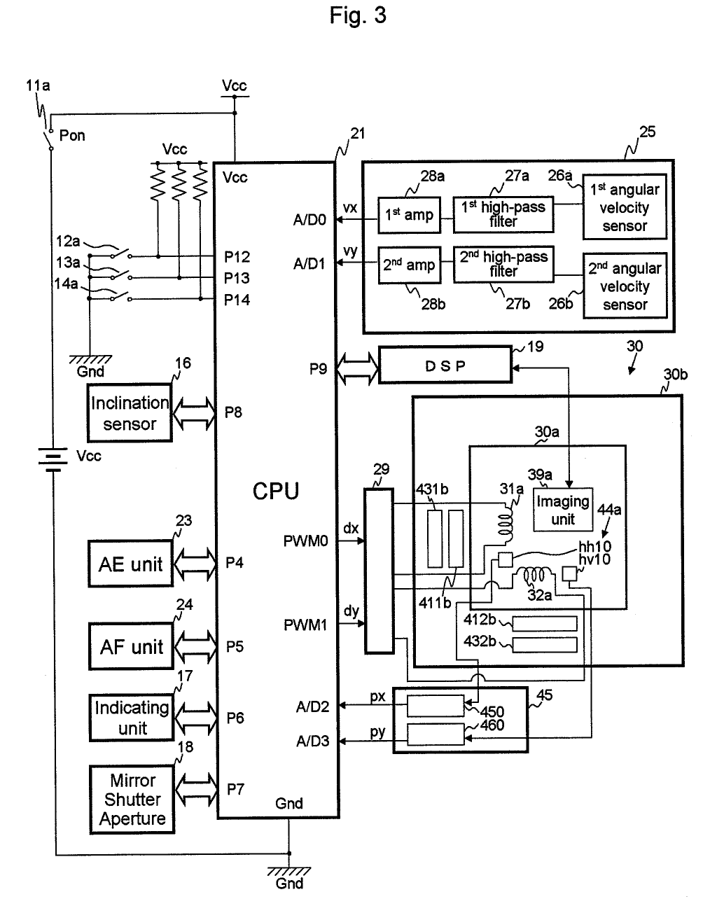

The imaging and dust removal part (the dust removal apparatus) of the photographing apparatus 1 comprises a PON button 11, a PON switch 11a, a photometric switch 12a, a release button 13, a release switch 13a, an anti-shake button 14, an anti-shake switch 14a, an inclination sensor 16, an indicating unit 17 such as an LCD monitor etc., a mirror-aperture-shutter unit 18, a DSP 19, a CPU 21, an AE (automatic exposure) unit 23, an AF (automatic focus) unit 24, an anti-shake unit 30, and a camera lens 67 (see FIGS. 1, 2, and 3).

Whether the PON switch 11a is in the ON state or the OFF state is determined by the state of the PON button 11, so that the ON/OFF states of the photographing apparatus 1 correspond to the ON/OFF states of the PON switch 11a.

The photographic subject image is captured as the optical image through the camera lens 67 by the imaging unit 39a, and the captured image is displayed on the indicating unit 17. The photographic subject image can be optically observed by the optical finder (not depicted).

Further, after the PON button 11 is depressed so that the photographing apparatus 1 is set to the ON state, an inclination detection operation is performed by the inclination sensor 16 and then a dust removal operation is performed in a first time period (220 ms).

When the release button 13 is partially depressed by the operator, the photometric switch 12a changes to the ON state so that the photometric operation, the AF sensing operation, and the focusing operation are performed.

When the release button 13 is fully depressed by the operator, the release switch 13a changes to the ON state so that the imaging operation by the imaging unit 39a (the imaging apparatus) is performed, and the image which is captured, is stored.

The inclination sensor 16, which is connected to port P8 of the CPU 21, detects the inclination of the photographing apparatus 1 (a first angle between the direction of gravity and the first direction x, and a second angle between the direction of gravity and the second direction y), and outputs information regarding the inclination by using output of the High (voltage) signal and output of the Low (voltage) signal.

The CPU 21 specifies a holding position of the photographing apparatus 1 by the operator (in relationship to the direction of gravity) on the basis of the information regarding the detected inclination.

As the holding position of the photographing apparatus 1, the CPU 21 specifies one of a first horizontal position, a second horizontal position, a first vertical position, and a second vertical position.

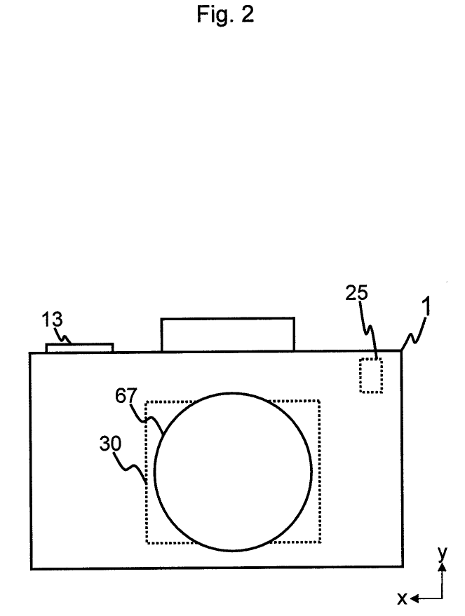

In the first horizontal position, the photographing apparatus 1 is held in the horizontal position where the upper surface of the photographing apparatus 1 faces upward (the positive direction of the second direction y points upward, see FIGS. 1 and 2).

In the second horizontal position, the photographing apparatus 1 is held in the horizontal position where the lower surface of the photographing apparatus 1 faces upward (the negative direction of the second direction y points upward).

In the first vertical position, the photographing apparatus 1 is held in the vertical position where the left side surface viewed from a front side of the photographing apparatus 1 faces upward (the positive direction of the first direction x points upward).

In the second vertical position, the photographing apparatus 1 is held in the vertical position where the right side surface viewed from the front side of the photographing apparatus 1 faces upward (the negative direction of the first direction x points upward).

In the embodiment, in the case that the holding position of the photographing apparatus 1 is in neither the first horizontal position, the second horizontal position, the first vertical position, nor the second vertical position, such as the case where the front side or the back side of the photographing apparatus 1 faces upward, etc., the dust removal operation is performed as the photographing apparatus 1 is held in the horizontal position.

However, as for this case, there is little influence by the force of gravity on striking the movable unit 30a against the boundary of the range of movement of the movable unit 30a. Accordingly, the dust removal operation may be performed as the photographing apparatus 1 is held in the vertical position.

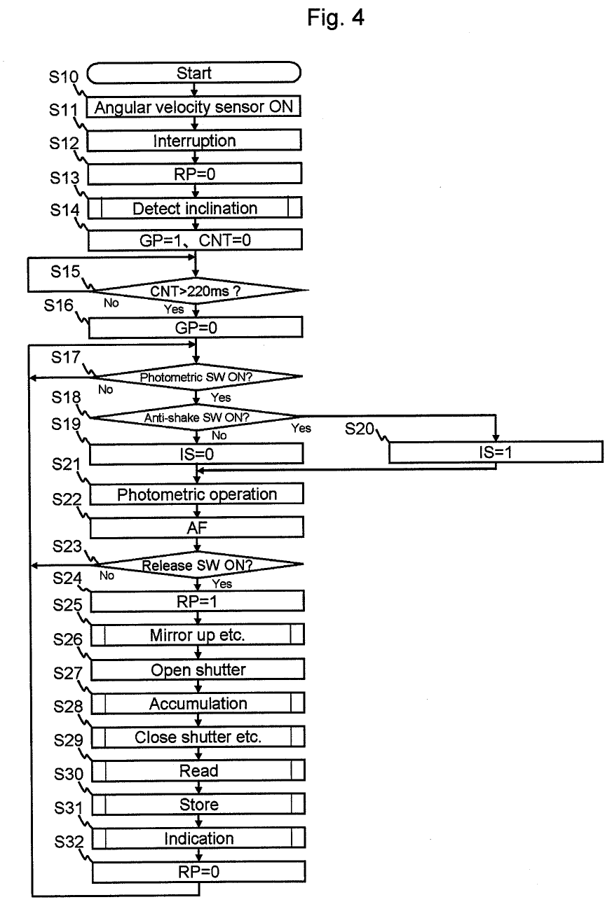

The inclination detection operation for the photographing apparatus 1 is performed by the inclination sensor 16 immediately after the photographing apparatus 1 is set to the ON state, and before the dust removal operation commences (see step S13 in FIG. 4).

The holding position of the photographing apparatus 1 by the operator, which is specified by the inclination sensor 16 and the CPU 21 on the basis of the detected inclination, is used for determining the direction of movement of the movable unit 30a in the dust removal operation.

The mirror-aperture-shutter unit 18 is connected to port P7 of the CPU 21 and performs an UP/DOWN operation of the mirror (a mirror-up operation and a mirror-down operation), an OPEN/CLOSE operation of the aperture, and an OPEN/CLOSE operation of the shutter corresponding to the ON state of the release switch 13a.

The DSP 19 is connected to port P9 of the CPU 21, and it is connected to the imaging unit 39a. Based on a command from the CPU 21, the DSP 19 performs the calculation operations, such as the image processing operation etc., on the image signal obtained by the imaging operation of the imaging unit 39a.

The CPU 21 is a control apparatus that controls each part of the photographing apparatus 1 regarding the imaging operation, the dust removal operation, and the anti-shake operation (i.e. the image stabilizing operation). The anti-shake operation includes both the movement of the movable unit 30a and position-detection efforts.

Further, the CPU 21 stores a value of the anti-shake parameter IS that determines whether the photographing apparatus 1 is in the anti-shake mode or not, a value of a release state parameter RP, a value of a dust removal state parameter GP, and a value of a dust removal time parameter CNT.

The value of the release state parameter RP changes with respect to the release sequence operation. When the release sequence operation is performed, the value of the release state parameter RP is set to 1 (see steps S24 to S31 in FIG. 4); and when the release sequence operation is finished, the value of the release state parameter RP is set (reset) to 0 (see steps S13 and S32 in FIG. 4).

The dust removal state parameter GP is a parameter that indicates whether the dust removal operation is finished.

The value of the dust removal state parameter GP is set to 1 when the dust removal operation is underway, from the point immediately after the photographing apparatus 1 is set to the ON state until the first time period (220 ms) has elapsed (see step S14 in FIG. 4).

The value of the dust removal state parameter GP is set to 0 when the dust removal operation is finished, from the point when the first time period (220 ms) has elapsed after the photographing apparatus 1 is set to the ON state (see step S16 in FIG. 4).

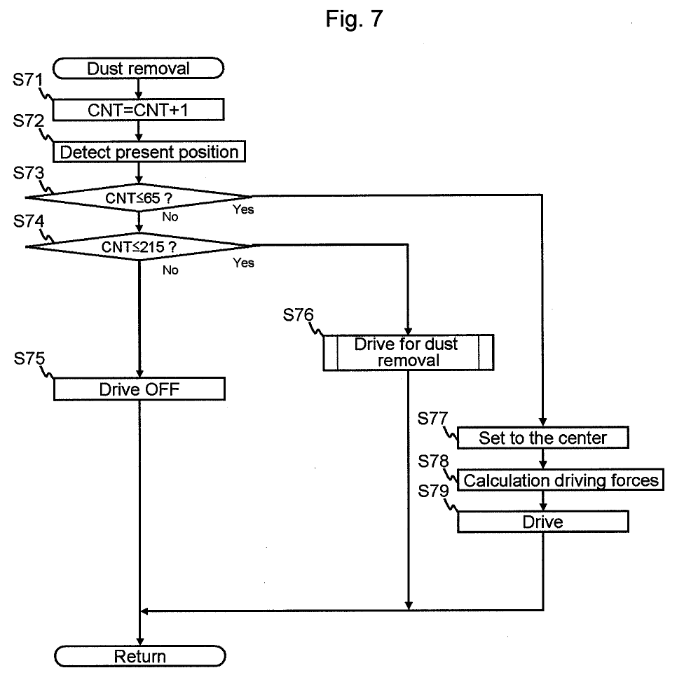

The dust removal time parameter CNT is used for measuring the length of time the dust removal operation is underway. An initial value of the dust removal time parameter CNT is set to 0. While the dust removal operation is being performed, the value of the dust removal time parameter CNT is increased by the value of 1 at every predetermined time interval of 1 ms. (see step S71 in FIG. 7).

The CPU 21 moves the movable unit 30a to the predetermined position in the dust removal operation before the anti-shake operation (the centering operation, see step S77 in FIG. 7). In the embodiment, the predetermined position is the center of the range of movement (where the coordinate values in the first direction x and in the second direction y are both 0).

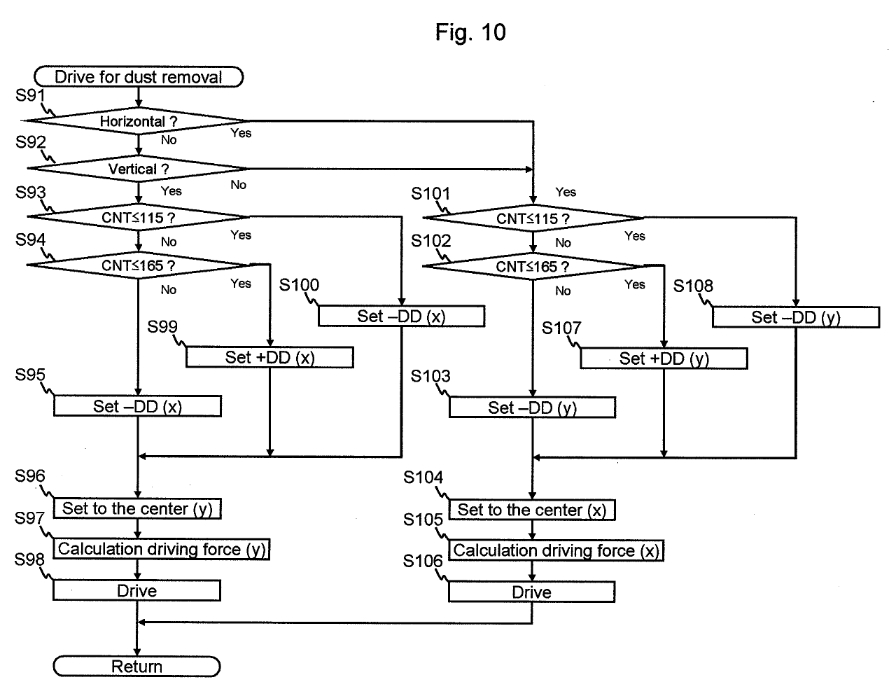

Then, the CPU 21 moves the movable unit 30a to strike against one side of the boundary of the range of movement of the movable unit 30a in one of either the first direction x or the second direction y under the condition where the coordinate value in the other of the first direction x or the second direction y of the movable unit 30a is held constant at the center (a primary collision, see steps S100 and S108 in FIG. 10).

Next, the CPU 21 moves the movable unit 30a to strike against the other side of the boundary of the range of movement of the movable unit 30a in one of either the first direction x or the second direction y under the condition where the coordinate value in the other of the first direction x or the second direction y of the movable unit 30a is held constant at the center (a secondary collision, see steps S99 and S107 in FIG. 10).

Finally, the CPU 21 moves the movable unit 30a to strike against one side of the boundary of the range of movement of the movable unit 30a in one of either the first direction x or the second direction y again, under the condition where the coordinate value in the other of the first direction x or the second direction y of the movable unit 30a is held constant at the center (a final collision, see steps S95 and S103 in FIG. 10). Namely, the movable unit 30a strikes against the boundary of the range of movement of the movable unit 30a (against the fixed unit 30b) three times in total during one, dust removal operation.

The dust on the imaging unit 39a of the movable unit 30a (the imaging device and the low-pass filter) is removed by the shock of the impact of the movable unit 30a against the boundary of the range of movement of the movable unit 30a.

After the dust removal operation is complete, the anti-shake operation commences.

Specifically, in the primary collision of the dust removal operation, the movable unit 30a is moved from the predetermined position (the center of the range of movement) to one (first) side of the boundary of the range of movement of the movable unit 30a in one of either the first direction x or the second direction y.

In the secondary collision of the dust removal operation, the movable unit 30a is moved from one side of the boundary of the range of movement of the movable unit 30a to the other side of the boundary of the range of movement of the movable unit 30a in one of either the first direction x or the second direction y.

In the final collision of the dust removal operation, the movable unit 30a is moved from the other side of the boundary of the range of movement of the movable unit 30a back to the first side of the boundary of the range of movement of the movable unit 30a in one of either the first direction x or the second direction y.

Therefore, a force of impact in the primary collision is less than a force of impact in the secondary (and final) collision.

With the smaller force of impact in the primary collision, the movable unit 30a is prepared (primed) in a condition to facilitate the ease of dust removal. Next, by the large force of impact in the secondary (or final) collision, whose force of impact is greater than that of the primary collision, the dust on the imaging unit 39a of the movable unit 30a is removed.

Therefore, damage to the imaging device of the imaging unit 39a can be restrained and the dust can be removed efficiently, compared to the case where the movable unit 30a is moved to the boundary of the range of movement of the movable unit 30a without the centering operation.

In the dust removal operation, the direction of movement of the movable unit 30a to the boundary of the range of movement of the movable unit 30a is determined on the basis of the holding position (direction) of the photographing apparatus 1.

In other words, the movable unit 30a is moved in the immediate direction in relationship to the direction of gravity among the first direction x and the second direction y (corresponding to the smaller of either the first angle between the direction of gravity and the first direction x or the second angle between the direction of gravity and the second direction y).

At the same time, the movable unit 30a is held constant in the immediate direction in relationship to the direction perpendicular to the direction of gravity among the first direction x and the second direction y (corresponding to the larger of either the first angle or the second angle).

Specifically, in the first horizontal position or the second horizontal position, the movable unit 30a is moved in the second direction y under the condition where the coordinate value in the first direction x of the movable unit 30a is held constant at the center.

Similarly, in the first vertical position or the second vertical position, the movable unit 30a is moved in the first direction x under the condition where the coordinate value in the second direction y of the movable unit 30a is held constant at the center.

Therefore, the movable unit 30a can be moved in the immediate direction in relationship to the direction of gravity and the lower direction, so that the force of gravity can influence the striking of the movable unit 30a against the boundary of the range of movement of the movable unit 30a; the force of impact can be increased; and the dust removal operation can be performed with greater effectiveness compared to when the force of gravity does not influence the striking of the movable unit 30a against the boundary of the range of movement of the movable unit 30a.

Further, the CPU 21 stores values of a first digital angular velocity signal Vxₙ, a second digital angular velocity signal Vyₙ, a first digital angular velocity Vvxₙ, a second digital angular velocity VVyₙ, a digital displacement angle Bxₙ, a second digital displacement angle Byₙ, a coordinate of position Sₙ in the first direction x: Sxₙ, a coordinate of position Sₙ in the second direction y: Syₙ, a first driving force Dxₙ, a second driving force Dyₙ, a coordinate of position Pₙ after A/D conversion in the first direction x: pdxₙ, a coordinate of position Pₙ after A/D conversion in the second direction y: pdyₙ, a first subtraction value exₙ, a second subtraction value eyₙ, a first proportional coefficient Kx, a second proportional coefficient Ky, a sampling cycle θ of the anti-shake operation, a first integral coefficient Tix, a second integral coefficient Tiy, a first differential coefficient Tdx, and a second differential coefficient Tdy.

The AE unit (an exposure calculating unit) 23 performs the photometric operation and calculates the photometric values, based on the subject being photographed. The AE unit 23 also calculates the aperture value and the time length of the exposure, with respect to the photometric values, both of which are needed for imaging. The AF unit 24 performs the AF sensing operation and the corresponding focusing operation, both of which are needed for imaging. In the focusing operation, the camera lens 67 is re-positioned along the optical axis in the LX direction.

The anti-shake part (the anti-shake apparatus) of the photographing apparatus 1 comprises an anti-shake button 14, an anti-shake switch 14a, an indicating unit 17, a CPU 21, an angular velocity detection unit 25, a driver circuit 29, an anti-shake unit 30, a hall-element signal-processing unit 45 (a magnetic-field change-detecting element), and the camera lens 67.

When the anti-shake button 14 is depressed by the operator, the anti-shake switch 14a is changed to the ON state so that the anti-shake operation, in which the angular velocity detection unit 25 and the anti-shake unit 30 are driven independently of the other operations which include the photometric operation etc., is carried out at the predetermined time interval. When the anti-shake switch 14a is in the ON state, in other words in the anti-shake mode, the anti-shake parameter IS is set to 1 (IS=1). When the anti-shake switch 14a is not in the ON state, in other words in the non-anti-shake mode, the anti-shake parameter IS is set to 0 (IS=0). In the embodiment, the value of the predetermined time interval is set to 1 ms.

The various output commands corresponding to the input signals of these switches are controlled by the CPU 21.

The information regarding whether the photometric switch 12a is in the ON state or OFF state is input to port P12 of the CPU 21 as a 1-bit digital signal. The information regarding whether the release switch 13a is in the ON state or OFF state is input to port P13 of the CPU 21 as a 1-bit digital signal. The information regarding whether the anti-shake switch 14a is in the ON state or OFF state is input to port P14 of the CPU 21 as a 1-bit digital signal.

The AE unit 23 is connected to port P4 of the CPU 21 for inputting and outputting signals. The AF unit 24 is connected to port P5 of the CPU 21 for inputting and outputting signals. The indicating unit 17 is connected to port P6 of the CPU 21 for inputting and outputting signals.

Next, the details of the input and output relationships between the CPU 21 and the angular velocity detection unit 25, the driver circuit 29, the anti-shake unit 30, and the hall-element signal-processing unit 45 are explained.

The angular velocity detection unit 25 has a first angular velocity sensor 26a, a second angular velocity sensor 26b, a first high-pass filter circuit 27a, a second high-pass filter circuit 27b, a first amplifier 28a and a second amplifier 28b.

The first angular velocity sensor 26a detects the angular velocity of a rotary motion (the yawing) of the photographing apparatus 1 about the axis of the second direction y (the velocity-component in the first direction x of the angular velocity of the photographing apparatus 1). The first angular velocity sensor 26a is a gyro sensor that detects a yawing angular velocity.

The second angular velocity sensor 26b detects the angular velocity of a rotary motion (the pitching) of the photographing apparatus 1 about the axis of the first direction x (detects the velocity-component in the second direction y of the angular velocity of the photographing apparatus 1). The second angular velocity sensor 26b is a gyro sensor that detects a pitching angular velocity.

The first high-pass filter circuit 27a reduces a low frequency component of the signal output from the first angular velocity sensor 26a, because the low frequency component of the signal output from the first angular velocity sensor 26a includes signal elements that are based on a null voltage and a panning-motion, neither of which are related to hand-shake.

The second high-pass filter circuit 27b reduces a low frequency component of the signal output from the second angular velocity sensor 26b, because the low frequency component of the signal output from the second angular velocity sensor 26b includes signal elements that are based on a null voltage and a panning-motion, neither of which are related to hand-shake.

The first amplifier 28a amplifies a signal regarding the yawing angular velocity, whose low frequency component has been reduced, and outputs the analog signal to the A/D converter A/D 0 of the CPU 21 as a first angular velocity vx.

The second amplifier 28b amplifies a signal regarding the pitching angular velocity, whose low frequency component has been reduced, and outputs the analog signal to the A/D converter A/D 1 of the CPU 21 as a second angular velocity vy.

The reduction of the low frequency signal component is a two-step process; the primary part of the analog high-pass filter processing operation is performed first by the first and second high-pass filter circuits 27a and 27b, followed by the secondary part of the digital high-pass filter processing operation that is performed by the CPU 21.

The cut-off frequency of the secondary part of the digital high-pass filter processing operation is higher than that of the primary part of the analog high-pass filter processing operation.

In the digital high-pass filter processing operation, the value of a time constant (a first high-pass filter time constant hx and a second high-pass filter time constant hy) can be easily changed.

The supply of electric power to the CPU 21 and each part of the angular velocity detection unit 25 begins after the PON switch 11a is set to the ON state (the main power supply is set to the ON state). The calculation of a hand-shake quantity begins after the PON switch 11a is set to the ON state and the inclination detection operation and the dust removal operation are both finished.

The CPU 21 converts the first angular velocity vx, which is input to the A/D converter A/D 0, to a first digital angular velocity signal Vxₙ (A/D conversion operation); calculates a first digital angular velocity VVxₙ by reducing a low frequency component of the first digital angular velocity signal Vxₙ (the digital high-pass filter processing operation) because the low frequency component of the first digital angular velocity signal Vxₙ includes signal elements that are based on a null voltage and a panning-motion, neither of which are related to hand-shake; and calculates a hand shake quantity (a hand shake displacement angle: a first digital displacement angle Bxₙ) by integrating the first digital angular velocity VVxₙ (the integration processing operation).

Similarly, the CPU 21 converts the second angular velocity vy, which is input to the A/D converter A/D 1, to a second digital angular velocity signal Vyₙ (A/D conversion operation); calculates a second digital angular velocity VVyₙ by reducing a low frequency component of the second digital angular velocity signal Vyₙ (the digital high-pass filter processing operation) because the low frequency component of the second digital angular velocity signal Vyₙ includes signal elements that are based on a null voltage and a panning-motion, neither of which are related to hand-shake; and calculates a hand shake quantity (a hand shake displacement angle: a second digital displacement angle Byₙ) by integrating the second digital angular velocity VVyₙ (the integration processing operation).

Accordingly, the CPU 21 and the angular velocity detection unit 25 use a function to calculate the hand-shake quantity.

“n” is an integer that is greater than 0 and indicates a length of time (ms) from the commencement of the interruption process of the timer commences, (t=0; see step S11 in FIG. 4) to the point when the latest anti-shake operation is performed (t=n).

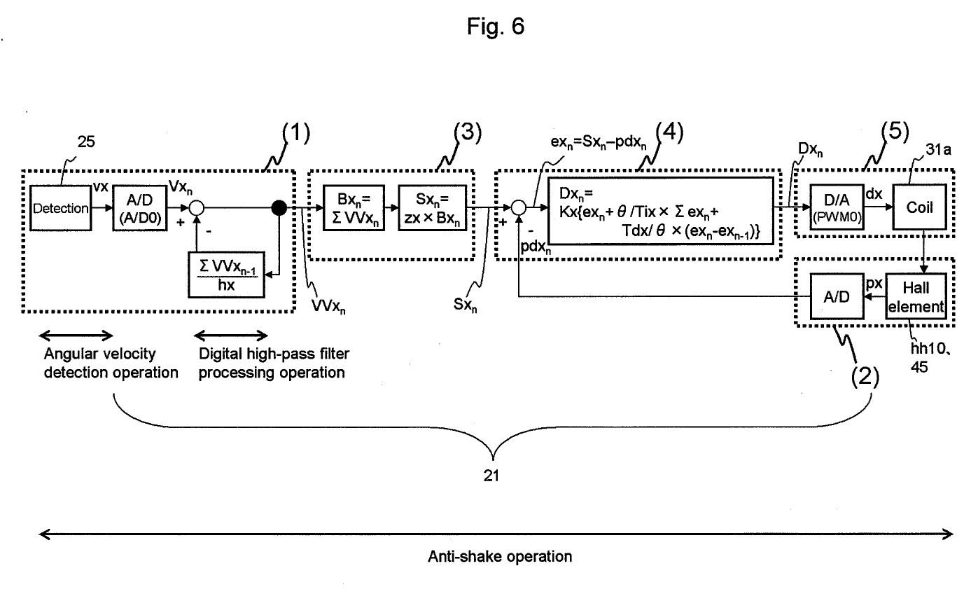

In the digital high-pass filter processing operation regarding the first direction x, the first digital angular velocity VVxₙ is calculated by dividing the summation of the first digital angular velocity VVx₀ to VVXₙ₋₁ calculated by the interruption process of the timer before the 1 ms predetermined time interval (before the latest anti-shake operation is performed), by the first high-pass filter time constant hx, and then subtracting the resulting quotient from the first digital angular velocity signal Vxₙ (VVxₙ=Vxₙ−(ΣVVxₙ₋₁)÷hx, see (1) in FIG. 6).

In the digital high-pass filter processing operation regarding the second direction y, the second digital angular velocity VVyₙ is calculated by dividing the summation of the second digital angular velocity VVy₀ to VVyₙ₋₁ calculated by the interruption process of the timer before the 1 ms predetermined time interval (before the latest anti-shake operation is performed), by the second high-pass filter time constant hy, and then subtracting the resulting quotient from the second digital angular velocity signal Vyₙ (VVyₙ=Vyₙ−(ΣVVyₙ₋₁)÷hy).

In the embodiment, the angular velocity detection operation in (portion of) the interruption process of the timer includes a process in the angular velocity detection unit 25 and a process of inputting the first and second angular velocities vx and vy from the angular velocity detection unit 25 to the CPU 21.

In the integration processing operation regarding the first direction x, the first digital displacement angle Bxₙ is calculated by the summation from the first digital angular velocity VVx₀ at the point when the interruption process of the timer commences, t=0, (see step S11 in FIG. 4) to the first digital angular velocity VVxₙ at the point when the latest anti-shake operation is performed (t=n), (Bxₙ=ΣVVxₙ, see (3) in FIG. 6).

Similarly, in the integration processing operation regarding the second direction y, the second digital displacement angle Byₙ is calculated by the summation from the second digital angular velocity VVy₀ at the point when the interruption process of the timer commences to the second digital angular velocity VVyₙ at the point when the latest anti-shake operation is performed (Byₙ=ΣVVyₙ).

The CPU 21 calculates the position Sₙ where the imaging unit 39a (the movable unit 30a) should be moved, corresponding to the hand-shake quantity (the first and second digital displacement angles Bxₙ and Byₙ) that is calculated for the first direction x and the second direction y on the basis of a position conversion coefficient zz (a first position conversion coefficient zx for the first direction x and a second position conversion coefficient zy for the second direction y).

The coordinate of position Sₙ in the first direction x is defined as Sxₙ, and the coordinate of position Sₙ in the second direction y is defined as Syₙ. The movement of the movable unit 30a, which includes the imaging unit 39a, is performed by using electro-magnetic force, and is described later.

The driving force Dₙ drives the driver circuit 29 in order to move the movable unit 30a to the position Sₙ. The coordinate of the driving force Dₙ in the first direction x is defined as the first driving force Dxₙ (after D/A conversion: a first PWM duty dx). The coordinate of the driving force Dₙ in the second direction y is defined as the second driving force Dyₙ (after D/A conversion: a second PWM duty dy).

The first PWM duty dx is a duty ratio of the driving pulse corresponding to the first driving force Dxₙ. The second PWM duty dy is a duty ratio of the driving pulse corresponding to the second driving force Dyₙ.

However, the position Sₙ where the imaging unit 39a (the movable unit 30a) should be moved in the first time period (220 ms) for the dust removal operation before the anti-shake operation is performed, is set to a value that does not correspond to the hand-shake quantity (see steps S96 and S104 in FIG. 10).

In a positioning operation regarding the first direction x, the coordinate of position Sₙ in the first direction x is defined as Sxₙ, and is the product of the latest first digital displacement angle Bxₙ and the first position conversion coefficient zx (Sxₙ=zx×Bxₙ, see (3) in FIG. 6).

In a positioning operation regarding the second direction y, the coordinate of position Sₙ in the second direction y is defined as Syₙ, and is the product of the latest second digital displacement angle Byₙ and the second position conversion coefficient zy (Syₙ=zy×Byₙ).

The anti-shake unit 30 is an apparatus that corrects for the hand-shake effect by moving the imaging unit 39a to the position Sₙ, by canceling the lag of the photographing subject image on the imaging surface of the imaging device of the imaging unit 39a, and by stabilizing the photographing subject image displayed on the imaging surface of the imaging device during the exposure time when the anti-shake operation is performed (IS=1).

The anti-shake unit 30 has a fixed unit 30b that forms the boundary of the range of movement of the movable unit 30a, and a movable unit 30a which includes the imaging unit 39a and can be moved about on the xy plane that is parallel to the first direction x and the second direction y.

During the exposure time when the anti-shake operation is not performed (IS=0), the movable unit 30a is fixed to (held in) the predetermined position (at the center of the range of movement).

In the first time period (220 ms), after the photographing apparatus 1 is set to the ON state, the movable unit 30a is driven to the predetermined position that is the center of the range of movement. Next, the movable unit 30a is driven to (is struck against) the boundary of the range of movement in one of either the first direction x or the second direction y.

Otherwise (except for the first time period and the exposure time), the movable unit 30a is not driven (moved).

The anti-shake unit 30 does not have a fixed-positioning mechanism that maintains the movable unit 30a in a fixed position when the movable unit 30a is not being driven (drive OFF state).

The driving of the movable unit 30a of the anti-shake unit 30, including movement to a predetermined fixed (held) position, is performed by the electro-magnetic force of the coil unit for driving and the magnetic unit for driving, through the driver circuit 29 which has the first PWM duty dx input from the PWM 0 of the CPU 21 and has the second PWM duty dy input from the PWM 1 of the CPU 21 (see (5) in FIG. 6).

The detected-position Pₙ of the movable unit 30a, either before or after the movement effected by the driver circuit 29, is detected by the hall element unit 44a and the hall-element signal-processing unit 45.

Information regarding the first coordinate of the detected-position Pₙ in the first direction x, in other words a first detected position signal px, is input to the A/D converter A/D 2 of the CPU 21 (see (2) in FIG. 6). The first detected position signal px is an analog signal that is converted to a digital signal by the A/D converter A/D 2 (A/D conversion operation). The first coordinate of the detected-position Pₙ in the first direction x, after the A/D conversion operation, is defined as pdxₙ and corresponds to the first detected position signal px.

Information regarding the second coordinate of the detected-position Pₙ in the second direction y, in other words a second detected position signal py, is input to the A/D converter A/D 3 of the CPU 21. The second detected position signal py is an analog signal that is converted to a digital signal by the A/D converter A/D 3 (A/D conversion operation). The second coordinate of the detected-position Pₙ in the second direction y, after the A/D conversion operation, is defined as pdyₙ and corresponds to the second detected position signal py.

The PID (Proportional Integral Differential) control calculates the first and second driving forces Dxₙ and Dyₙ on the basis of the coordinate data for the detected-position Pₙ (pdxₙ, pdyₙ) and the position Sₙ (Sxₙ, Syₙ) following movement.

The calculation of the first driving force Dxₙ is based on the first subtraction value exₙ, the first proportional coefficient Kx, the sampling cycle θ, the first integral coefficient Tix, and the first differential coefficient Tdx (Dxₙ=Kx×{exₙ+θ÷Tix×Σexₙ+Tdx÷θ×(exₙ−exₙ₋₁)} see (4) in FIG. 6). The first subtraction value exₙ is calculated by subtracting the first coordinate of the detected-position Pₙ in the first direction x after the A/D conversion operation, pdxₙ, from the coordinate of position Sₙ in the first direction x, Sxₙ (exₙ=Sxₙ−pdxₙ).

The calculation of the second driving force Dyₙ is based on the second subtraction value eyₙ, the second proportional coefficient Ky, the sampling cycle θ, the second integral coefficient Tiy, and the second differential coefficient Tdy (Dyₙ=Ky×{eyₙ+θ÷Tiy×Σeyₙ+Tdy÷θ×(eyₙ−eyₙ₋₁)}). The second subtraction value eyₙ is calculated by subtracting the second coordinate of the detected-position Pₙ in the second direction y after the A/D conversion operation, pdyₙ, from the coordinate of position Sₙ in the second direction y, Syₙ (eyₙ=Syₙ−pdyₙ).

The value of the sampling cycle θ is set to the predetermined time interval of 1 ms.

Driving the movable unit 30a to the position Sₙ, (Sxₙ,Syₙ) corresponding to the anti-shake operation of the PID control, is performed when the photographing apparatus 1 is in the anti-shake mode (IS=1) where the anti-shake switch 14a is set to the ON state.

When the anti-shake parameter IS is 0, the PID control that does not correspond to the anti-shake operation is performed so that the movable unit 30a is moved to the center of the range of movement (the predetermined position).

In the dust removal operation, from the point when the photographing apparatus 1 is set to the ON state until the anti-shake operation commences, the movable unit 30a is first moved to the center of the range of movement, then moved to one side of the boundary of the range of movement in one of either the first direction x or the second direction y (the primary collision), then moved to the opposite side of the boundary of the range of movement in the same one of the first direction x or the second direction y as the previous movement (the secondary collision), then moved again to the original side of the boundary of the range of movement in the same one of the first direction x or the second direction y as the previous movement (the final collision), in order. In this period, the coordinate of the movable unit 30a in the other one of the first direction x or the second direction y is held constant at the center.

The movable unit 30a has a coil unit for driving that is comprised of a first driving coil 31a and a second driving coil 32a, an imaging unit 39a that has the imaging device, and a hall element unit 44a as a magnetic-field change-detecting element unit. In the embodiment, the imaging device is a CCD; however, the imaging device may be another imaging device such as a CMOS etc.

A rectangle shape, which is the form of the imaging surface of the imaging device, has two sides that are parallel to the first direction x and has two sides that are parallel to the second direction y and that are shorter than the two sides parallel to the first direction x, under the condition where the control of movement of the movable unit 30a is not performed.

However, the two sides that are parallel to the second direction y may be longer than or equal to the two sides that are parallel to the first direction x.

The fixed unit 30b has a magnetic unit for driving that is comprised of a first position-detecting and driving magnet 411b, a second position-detecting and driving magnet 412b, a first position-detecting and driving yoke 431b, and a second position-detecting and driving yoke 432b.

The fixed unit 30b movably supports the movable unit 30a in the first direction x and in the second direction y.

The fixed unit 30b has a buffer member that absorbs the shock at the point of contact with the movable unit 30a (at the boundary of the range of movement).

The hardness of the buffer member is set so that the part making contact, such as the movable unit 30a etc., is not damaged by the shock of the impact, and the dust on the movable unit 30a is removed by the shock of the impact when the movable unit 30a is moved to the boundary of the range of movement of the movable unit 30a and struck against the fixed unit 30b through the buffer member.

In the embodiment, the buffer member is attached to the fixed unit 30b, however; the buffer member may be attached to the movable unit 30a.

When the center area of the imaging device intersects by the optical axis LX of the camera lens 67, the relationship between the position of the movable unit 30a and the position of the fixed unit 30b is arranged so that the movable unit 30a is positioned at the center of its range of movement in both the first direction x and the second direction y, in order to utilize the full size of the imaging range of the imaging device.

The rectangle shape, which is the form of the imaging surface of the imaging device, has two diagonal lines. In the embodiment, the center of the imaging device is at the intersection of these two diagonal lines.

The first driving coil 31a, the second driving coil 32a, and the hall element unit 44a are attached to the movable unit 30a.

The first driving coil 31a forms a seat and a spiral shaped coil pattern. The coil pattern of the first driving coil 31a has lines which are parallel to the second direction y, thus creating the first electro-magnetic force to move the movable unit 30a that includes the first driving coil 31a, in the first direction x.

The first electro-magnetic force occurs on the basis of the current direction of the first driving coil 31a and the magnetic-field direction of the first position-detecting and driving magnet 411b.

The second driving coil 32a forms a seat and a spiral shaped coil pattern. The coil pattern of the second driving coil 32a has lines which are parallel to the first direction x, thus creating the second electro-magnetic force to move the movable unit 30a that includes the second driving coil 32a, in the second direction y.

The second electro-magnetic force occurs on the basis of the current direction of the second driving coil 32a and the magnetic-field direction of the second position-detecting and driving magnet 412b.

The first and second driving coils 31a and 32a are connected to the driver circuit 29, which drives the first and second driving coils 31a and 32a, through the flexible circuit board (not depicted). The first PWM duty dx is input to the driver circuit 29 from the PWM 0 of the CPU 21, and the second PWM duty dy is input to the driver circuit 29 from the PWM 1 of the CPU 21. The driver circuit 29 supplies power to the first driving coil 31a that corresponds to the value of the first PWM duty dx, and to the second driving coil 32a that corresponds to the value of the second PWM duty dy, to drive the movable unit 30a.

The first position-detecting and driving magnet 411b is attached to the movable unit side of the fixed unit 30b, where the first position-detecting and driving magnet 411b faces the first driving coil 31a and the horizontal hall element hh10 in the third direction z.

The second position-detecting and driving magnet 412b is attached to the movable unit side of the fixed unit 30b, where the second position-detecting and driving magnet 412b faces the second driving coil 32a and the vertical hall element hv10 in the third direction z.

The first position-detecting and driving magnet 411b is attached to the first position-detecting and driving yoke 431b, under the condition where the N pole and S pole are arranged in the first direction x. The first position-detecting and driving yoke 431b is attached to the fixed unit 30b on the side of the movable unit 30a in the third direction z.

The second position-detecting and driving magnet 412b is attached to the second position-detecting and driving yoke 432b, under the condition where the N pole and S pole are arranged in the second direction y. The second position-detecting and driving yoke 432b is attached to the fixed unit 30b on the side of the movable unit 30a in the third direction z.

The first and second position-detecting and driving yokes 431b, 432b are made of a soft magnetic material.

The first position-detecting and driving yoke 431b prevents the magnetic-field of the first position-detecting and driving magnet 411b from dissipating to the surroundings, and raises the magnetic-flux density between the first position-detecting and driving magnet 411b and the first driving coil 31a, and between the first position-detecting and driving magnet 411b and the horizontal hall element hh10.

The second position-detecting and driving yoke 432b prevents the magnetic-field of the second position-detecting and driving magnet 412b from dissipating to the surroundings, and raises the magnetic-flux density between the second position-detecting and driving magnet 412b and the second driving coil 32a, and between the second position-detecting and driving magnet 412b and the vertical hall element hv10.

The hall element unit 44a is a single-axis unit that contains two magnetoelectric converting elements (magnetic-field change-detecting elements) utilizing the Hall Effect to detect the first detected position signal px and the second detected position signal py specifying the first coordinate in the first direction x and the second coordinate in the second direction y, respectively, of the present position Pₙ of the movable unit 30a.

One of the two hall elements is a horizontal hall element hh10 for detecting the first coordinate of the position Pₙ of the movable unit 30a in the first direction X, and the other is a vertical hall element hv10 for detecting the second coordinate of the position Pₙ of the movable unit 30a in the second direction y.

The horizontal hall element hh10 is attached to the movable unit 30a, where the horizontal hall element hh10 faces the first position-detecting and driving magnet 411b of the fixed unit 30b in the third direction z.

The vertical hall element hv10 is attached to the movable unit 30a, where the vertical hall element hv10 faces the second position-detecting and driving magnet 412b of the fixed unit 30b in the third direction z.

When the center of the imaging device intersects the optical axis LX, it is desirable to have the horizontal hall element hh10 positioned on the hall element unit 44a facing an intermediate area between the N pole and S pole of the first position-detecting and driving magnet 411b in the first direction x, as viewed from the third direction z. In this position, the horizontal hall element hh10 utilizes the maximum range in which an accurate position-detecting operation can be performed based on the linear output-change (linearity) of the single-axis hall element.

Similarly, when the center of the imaging device intersects the optical axis LX, it is desirable to have the vertical hall element hv10 positioned on the hall element unit 44a facing an intermediate area between the N pole and S pole of the second position-detecting and driving magnet 412b in the second direction y, as viewed from the third direction z.

The hall-element signal-processing unit 45 has a first hall-element signal-processing circuit 450 and a second hall-element signal-processing circuit 460.

The first hall-element signal-processing circuit 450 detects a horizontal potential-difference x10 between the output terminals of the horizontal hall element hh10 that is based on an output signal of the horizontal hall element hh10.

The first hall-element signal-processing circuit 450 outputs the first detected position signal px, which specifies the first coordinate of the position Pₙ of the movable unit 30a in the first direction x, to the A/D converter A/D 2 of the CPU 21, on the basis of the horizontal potential-difference x10.

The second hall-element signal-processing circuit 460 detects a vertical potential-difference y10 between the output terminals of the vertical hall element hv10 that is based on an output signal of the vertical hall element hv10.

The second hall-element signal-processing circuit 460 outputs the second detected position signal py, which specifies the second coordinate of the position Pₙ of the movable unit 30a in the second direction y, to the A/D converter A/D 3 of the CPU 21, on the basis of the vertical potential-difference y10.

Next, the main operation of the photographing apparatus 1 in the embodiment is explained by using the flowchart in FIG. 4.

When the photographing apparatus 1 is set to the ON state, the electrical power is supplied to the angular velocity detection unit 25 so that the angular velocity detection unit 25 is set to the ON state in step S10.

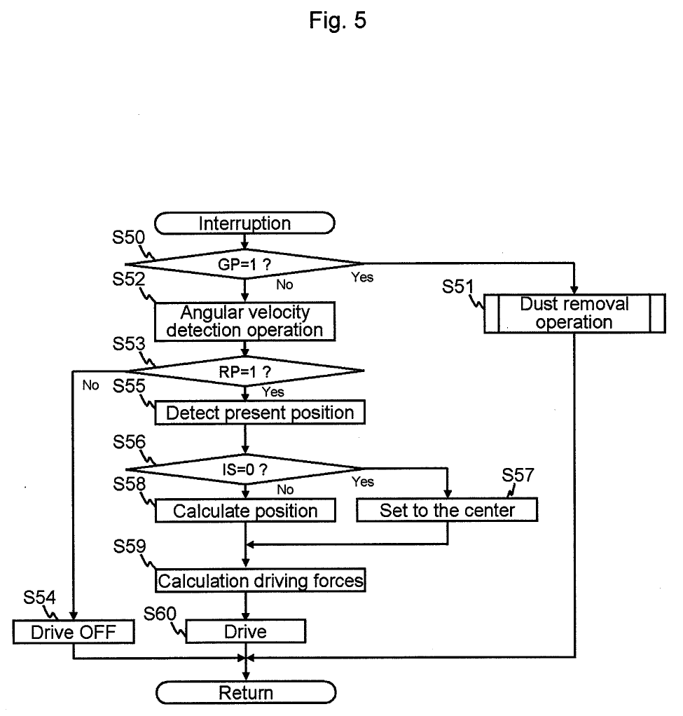

In step S11, the interruption process of the timer at the predetermined time interval (1 ms) commences. In step S12, the value of the release state parameter RP is set to 0. The detail of the interruption process of the timer is explained later by using the flowchart in FIG. 5.

In step S13, the inclination of the photographing apparatus 1 is detected by the inclination sensor 16 so that the CPU 21 specifies the holding position of the photographing apparatus 1 by the operator (in relationship to the direction of gravity) on the basis of the information regarding the detected inclination. As the holding position of the photographing apparatus 1, the CPU 21 specifies one of either the first horizontal position, the second horizontal position, the first vertical position, or the second vertical position.

In step S14, the value of the dust removal state parameter GP is set to 1, and the value of the dust removal time parameter CNT is set to 0.

In step S15, it is determined whether the value of the dust removal time parameter CNT is greater than 220. When it is determined that the value of the dust removal time parameter CNT is greater than 220, the operation continues to step S16; otherwise, the operation in step S15 is repeated.

In step S16, the value of the dust removal state parameter GP is set to 0.

In step S17, it is determined whether the photometric switch 12a is set to the ON state. When it is determined that the photometric switch 12a is set to the ON state, the operation continues to step S18; otherwise, the operation in step S17 is repeated.

In step S18, it is determined whether the anti-shake switch 14a is set to the ON state. When it is determined that the anti-shake switch 14a is not set to the ON state, the value of the anti-shake parameter IS is set to 0 in step S19; otherwise, the value of the anti-shake parameter IS is set to 1 in step S20.

In step S21, the AE sensor of the AE unit 23 is driven, the photometric operation is performed, and the aperture value and exposure time are calculated.

In step S22, the AF sensor and the lens control circuit of the AF unit 24 are driven to perform the AF sensing and focusing operations, respectively.

In step S23, it is determined whether the release switch 13a is set to the ON state. When the release switch 13a is not set to the ON state, the operation returns to step S17 and the process in steps S17 to S22 is repeated; otherwise, the operation continues on to step S24 and the release sequence operation commences.

In step S24, the value of the release state parameter RP is set to 1. In step S25, the mirror-up operation and the aperture closing operation corresponding to the aperture value, that is either preset or calculated, are performed by the mirror-aperture-shutter unit 18.

After the mirror-up operation is finished, the opening operation of the shutter (the movement of the front curtain in the shutter) commences, in step S26.

In step S27, the exposure operation, or in other words the electric charge accumulation of the imaging device (CCD etc.), is performed. After the exposure time has elapsed, the closing operation of the shutter (the movement of the rear curtain in the shutter), the mirror-down operation, and the opening operation of the aperture are performed by the mirror-aperture-shutter unit 18 in step S28.

In step S29, the electric charge which has accumulated in the imaging device during the exposure time is read. In step S30, the CPU 21 communicates with the DSP 19 so that the image processing operation is performed based on the electric charge read from the imaging device. The image, on which the image processing operation is performed, is stored to the memory in the photographing apparatus 1. In step S31, the image that is stored in the memory is displayed on the indicating unit 17. In step S32, the value of the release state parameter RP is set to 0 so that the release sequence operation is finished, and the operation then returns to step S17. In other words the photographing apparatus 1 is set to a state where the next imaging operation can be performed.

Next, the interruption process of the timer, which commences in step S11 in FIG. 4 and is performed at every predetermined time interval (1 ms) independent of the other operations, is explained by using the flowchart in FIG. 5.

When the interruption process of the timer commences, it is determined whether the value of the dust removal state parameter GP is set to 1, in step S50. When it is determined that the value of the dust removal state parameter GP is set to 1, the operation continues to step S51; otherwise, the operation proceeds directly to step S52.

In step S51, the dust removal operation is performed. The detail of the dust removal operation is explained later by using the flowchart in FIG. 7.

In step S52, the first angular velocity vx, which is output from the angular velocity detection unit 25, is input to the A/D converter A/D 0 of the CPU 21 and converted to the first digital angular velocity signal Vxₙ. The second angular velocity vy, which is also output from the angular velocity detection unit 25, is input to the A/D converter A/D 1 of the CPU 21 and converted to the second digital angular velocity signal Vyₙ (the angular velocity detection operation).

The low frequencies of the first and second digital angular velocity signals Vxₙ and Vyₙ are reduced in the digital high-pass filter processing operation (the first and second digital angular velocities VVxₙ and VVyₙ).

In step S53, it is determined whether the value of the release state parameter RP is set to 1. When it is determined that the value of the release state parameter RP is not set to 1, the driving control of the movable unit 30a is set to OFF state, in other words, the anti-shake unit 30 is set to a state where the driving control of the movable unit 30a is not performed in step S54; otherwise, the operation proceeds directly to step S55.

In step S55, the hall element unit 44a detects the position of the movable unit 30a, and the first and second detected position signals px and py are calculated by the hall-element signal-processing unit 45. The first detected position signal px is then input to the A/D converter A/D 2 of the CPU 21 and converted to a digital signal pdxₙ, whereas the second detected position signal py is input to the A/D converter A/D 3 of the CPU 21 and also converted to a digital signal pdyₙ, both of which thus determine the present position Pₙ (pdxₙ, pdyₙ) of the movable unit 30a.

In step S56, it is determined whether the value of the anti-shake parameter IS is 0. When it is determined that the value of the anti-shake parameter IS is 0 (IS=0), in other words when the photographing apparatus is not in anti-shake mode, the position Sₙ (Sxₙ, Syₙ) where the movable unit 30a (the imaging unit 39a) should be moved is set at the center of the range of movement of the movable unit 30a, in step S57. When it is determined that the value of the anti-shake parameter IS is not 0 (IS=1), in other words when the photographing apparatus is in anti-shake mode, the position Sₙ (Sxₙ, Syₙ) where the movable unit 30a (the imaging unit 39a) should be moved is calculated on the basis of the first and second angular velocities vx and vy, in step S58.

In step S59, the first driving force Dxₙ (the first PWM duty dx) and the second driving force Dyₙ (the second PWM duty dy) of the driving force Dₙ that moves the movable unit 30a to the position Sₙ, are calculated on the basis of the position Sₙ (Sxₙ, Syₙ) that was determined in step S57 or step S58, and the present position Pₙ (pdxₙ, pdyₙ).

In step S60, the first driving coil unit 31a is driven by applying the first PWM duty dx to the driver circuit 29, and the second driving coil unit 32a is driven by applying the second PWM duty dy to the driver circuit 29, so that the movable unit 30a is moved to position Sₙ (Sxₙ, Syₙ).

The process of steps S59 and S60 is an automatic control calculation that is used with the PID automatic control for performing general (normal) proportional, integral, and differential calculations.

Next, the dust removal operation, which commences in step S51 in FIG. 5, is explained by using the flowchart in FIG. 7.

When the dust removal operation commences, the value of the dust removal time parameter CNT is increased by 1, in step S71.

In step S72, the hall element unit 44a detects the position of the movable unit 30a, and the first and second detected position signals px and py are calculated by the hall-element signal-processing unit 45. The first detected position signal px is then input to the A/D converter A/D 2 of the CPU 21 and converted to a digital signal pdxₙ, whereas the second detected position signal py is input to the A/D converter A/D 3 of the CPU 21 and also converted to a digital signal pdyₙ, both of which thus determine the present position Pₙ (pdxₙ, pdyₙ) of the movable unit 30a.

In step S73, it is determined whether the value of the dust removal time parameter CNT is less than or equal to 65. When it is determined that the value of the dust removal time parameter CNT is less than or equal to 65, the operation proceeds directly to step S77; otherwise, the operation continues to step S74.

In step S74, it is determined whether the value of the dust removal time parameter CNT is less than or equal to 215. When it is determined that the value of the dust removal time parameter CNT is less than or equal to 215, the operation proceeds directly to step S76; otherwise, the operation continues to step S75.

In step S75, the driving control of the movable unit 30a is set to the OFF state, in other words, the anti-shake unit 30 is set to a state where the driving control of the movable unit 30a is not performed.

In step S76, driving (moving) the movable unit 30a for the dust removal operation is performed. The detail of driving the movable unit 30a for the dust removal operation is explained later by using the flowchart in FIG. 10.

In step S77, the position Sₙ (Sxₙ, Syₙ) where the movable unit 30a (the imaging unit 39a) should be moved is set at the center of the range of movement of the movable unit 30a.

In step S78, the first driving force Dxₙ (the first PWM duty dx) and the second driving force Dyₙ (the second PWM duty dy) of the driving force Dₙ that moves the movable unit 30a to the position Sₙ, are calculated on the basis of the position Sₙ (Sxₙ, Syₙ) that was determined in step S77, and the present position Pₙ (pdxₙ, pdyₙ).

In step S79, the first driving coil unit 31a is driven by applying the first PWM duty dx calculated in step S85 to the driver circuit 29, and the second driving coil unit 32a is driven by applying the second PWM duty dy calculated in step S78 to the driver circuit 29, so that the movable unit 30a is moved to position Sₙ (Sxₙ, Syₙ).

Next, the detail of driving the movable unit 30a for the dust removal operation is explained by using the flowchart in FIG. 10.

When driving the movable unit 30a for the dust removal operation commences, it is determined whether the photographing apparatus 1 is held in the horizontal position (one of either the first horizontal position or the second horizontal position), on the basis of the information regarding the inclination detected by the inclination sensor 16.

When it is determined that the photographing apparatus 1 is not held in the horizontal position, the operation continues to step S92; otherwise, the operation proceeds directly to step S101.

In step S92, it is determined whether the photographing apparatus 1 is held in the vertical position (one of either the first vertical position or the second vertical position), on the basis of the information regarding the inclination detected by the inclination sensor 16.

When it is determined that the photographing apparatus 1 is held in the vertical position, the operation continues to step S93; otherwise, the operation proceeds directly to step S101.

In step S93, it is determined whether the value of the dust removal time parameter CNT is less than or equal to 115. When it is determined that the value of the dust removal time parameter CNT is less than or equal to 115, the operation proceeds directly to step S100; otherwise, the operation continues to step S94.

In step S94, it is determined whether the value of the dust removal time parameter CNT is less than or equal to 165. When it is determined that the value of the dust removal time parameter CNT is less than or equal to 165, the operation proceeds directly to step S99; otherwise, the operation continues to step S95.

In steps S95 and S100, the value of the first PWM duty dx is set to −DD. In step S99, the value of the first PWM duty dx is set to +DD.

The absolute value |DD| (the absolute value of a dust removal duty ratio DD) is set so that the acceleration of the movable unit 30a in the first direction x at the point in time when the movable unit 30a is moved to and struck against the boundary of the range of movement of the movable unit 30a in the first direction x is increased to the degree where the dust on the movable unit 30a can be removed caused by the shock of the impact.

In step S96, the coordinate of position Sₙ in the second direction y, Syₙ, where the movable unit 30a (the imaging unit 39a) should be moved in the second direction y, is set at the center of the range of movement of the movable unit 30a in the second direction y.

In step S97, the second driving force Dyₙ (the second PWM duty dy) of the driving force Dₙ that moves (holds) the movable unit 30a to the position Sₙ in the second direction y (the center in the second direction y), is calculated on the basis of the coordinate of position Sₙ in the second direction y, Syₙ, that was determined in step S96, and the coordinate of the present position Pₙ after A/D conversion in the second direction y: pdyₙ.

In step S98, the first driving coil unit 31a is driven by applying the first PWM duty dx calculated in step S95, S99, or S100 to the driver circuit 29, and the second driving coil unit 32a is driven by applying the second PWM duty dy calculated in step S97 to the driver circuit 29, so that the movable unit 30a is moved to position Sₙ (Sxₙ, Syₙ).

In the first time period, from the point when the photographing apparatus 1 is set to the ON state to the point when the anti-shake operation commences, the movable unit 30a including the imaging device is moved to the center and then is moved to and struck against one side of the boundary and then the other side of the boundary of the range of movement of the movable unit 30a in the first direction x under the condition where the coordinate value in the second direction y of the movable unit 30a is held constant at the center.

The dust on the imaging unit 39a of the movable unit 30a (the imaging device and the low-pass filter) can be removed by the shock of the impact of the movable unit 30a against the boundary of the range of movement of the movable unit 30a.

In the dust removal operation, the position of the movable unit 30a in the second direction y is held constant at the center of the range of movement in the second direction y. Accordingly, the movable unit 30a in the second direction y does not make contact with the boundary of the range of movement in the second direction y while the movable unit 30a is moved in the first direction x. As a result, the movable unit 30a and the fixed unit 30b are not damaged.

Because the movable unit 30a is moved in the immediate direction in relationship to the direction of gravity and the lower direction, when the movable unit 30a is struck against one side of the boundary of the range of movement of the movable unit 30a in the first direction x, so that the force of gravity can influence the striking of the movable unit 30a against the boundary of the range of movement of the movable unit 30a; the force of impact can be increased; and the dust removal operation can be performed with greater effectiveness compared to when the movable unit 30a is struck against the other side of the boundary of the range of movement of the movable unit 30a in the first direction x.

In step S101, it is determined whether the value of the dust removal time parameter CNT is less than or equal to 115. When it is determined that the value of the dust removal time parameter CNT is less than or equal to 115, the operation proceeds directly to step S108; otherwise, the operation continues to step S102.

In step S102, it is determined whether the value of the dust removal time parameter CNT is less than or equal to 165. When it is determined that the value of the dust removal time parameter CNT is less than or equal to 165, the operation proceeds directly to step S107; otherwise, the operation continues to step S103.

In steps S103 and S108, the value of the second PWM duty dy is set to −DD. In step S107, the value of the second PWM duty dy is set to +DD.

The absolute value |DD| (the absolute value of a dust removal duty ratio DD) is set so that the acceleration of the movable unit 30a in the second direction y at the point in time when the movable unit 30a is moved to and struck against the boundary of the range of movement of the movable unit 30a in the second direction y is increased to the degree where the dust on the movable unit 30a can be removed by the shock of the impact.

In step S104, the coordinate of position Sₙ in the first direction x, Sxₙ, where the movable unit 30a (the imaging unit 39a) should be moved in the first direction x, is set at the center of the range of movement of the movable unit 30a in the first direction x.

In step S105, the first driving force Dxₙ (the first PWM duty dx) of the driving force Dₙ that moves (holds) the movable unit 30a to the position Sₙ in the first direction x (the center in the first direction x), is calculated on the basis of the coordinate of position Sₙ in the first direction x, Sxₙ, that was determined in step S104, and the coordinate of the present position Pₙ after A/D conversion in the first direction x: pdxₙ.

In step S106, the first driving coil unit 31a is driven by applying the first PWM duty dx calculated in step S105 to the driver circuit 29, and the second driving coil unit 32a is driven by applying the second PWM duty dy calculated in step S103, S107, or S108 to the driver circuit 29, so that the movable unit 30a is moved to position Sₙ (Sxₙ, Syₙ).

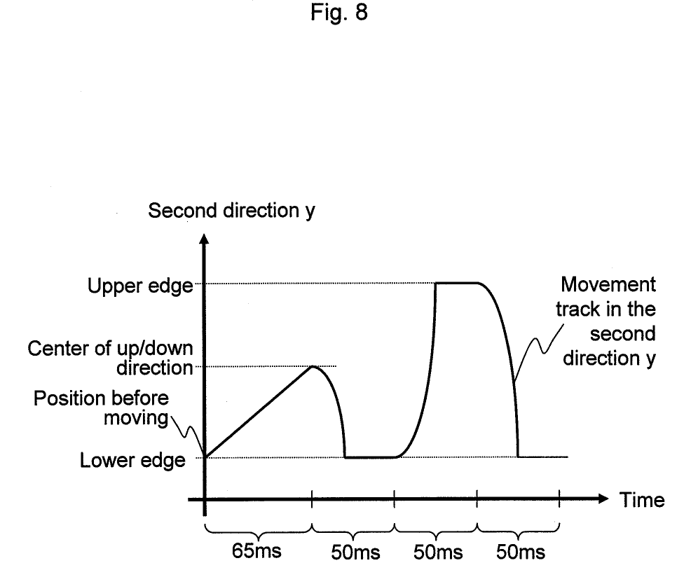

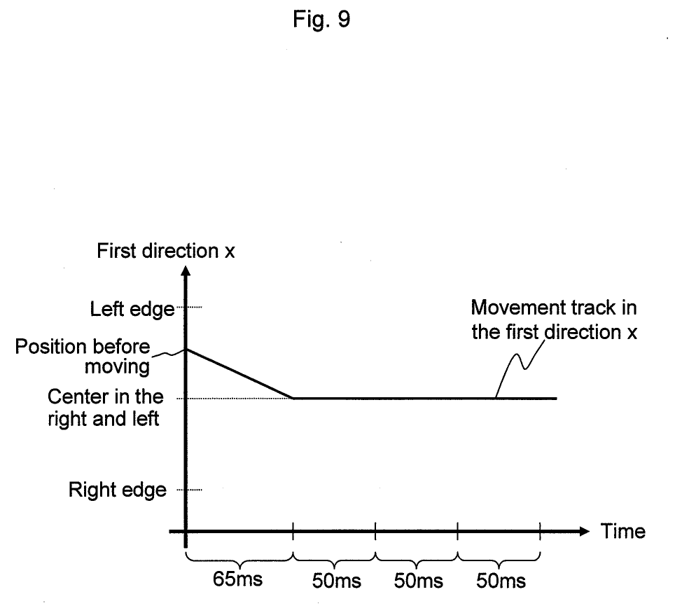

In the first time period, from the point when the photographing apparatus 1 is set to the ON state to the point when the anti-shake operation commences, the movable unit 30a including the imaging device is moved to the center and then is moved to and struck against one side of the boundary and then the other side of the boundary of the range of movement of the movable unit 30a in the second direction y under the condition where the coordinate value in the first direction x of the movable unit 30a is held constant at the center (see FIGS. 8 and 9).

The dust on the imaging unit 39a of the movable unit 30a (the imaging device and the low-pass filter) can be removed by the shock of the impact of the movable unit 30a against the boundary of the range of movement of the movable unit 30a.

In the dust removal operation, the position of the movable unit 30a in the first direction x is held constant at the center of the range of movement in the first direction x. Accordingly, the movable unit 30a in the first direction x does not make contact with the boundary of the range of movement in the first direction x while the movable unit 30a is moved in the second direction y. As a result, the movable unit 30a and the fixed unit 30b are not damaged.

Because the movable unit 30a is moved in the immediate direction in relationship to the direction of gravity and the lower direction, when the movable unit 30a is struck against one side of the boundary of the range of movement of the movable unit 30a in the second direction y, so that the force of gravity can influence the striking of the movable unit 30a against the boundary of the range of movement of the movable unit 30a; the force of impact can be increased; and the dust removal operation can be performed with greater effectiveness compared to when the movable unit 30a is struck against the other side of the boundary of the range of movement of the movable unit 30a in the second direction y.

In the embodiment, the movable unit 30a is moved in one of either the first direction x or the second direction y for the dust removal operation. However, the movable unit 30a may be moved in the smallest direction on the xy plane that is parallel to the first direction x and the second direction y, where an angle between this smallest direction and the direction of gravity is minimized.

In this case, a relationship between the direction of gravity and the holding position of the photographing apparatus 1 is specified on the basis of the detected inclination of the photographing apparatus 1, and then the movable unit 30a is moved to and struck against the boundary of the range of movement of the movable unit 30a in this smallest direction under the condition where the coordinate value in a direction perpendicular to this smallest direction of the movable unit 30a is held constant.

In the embodiment, the position where the movable unit 30a is moved to when the dust removal operation commences is not limited to the center of the range of movement of the movable unit 30a. It may be any position where the movable unit 30a does not make contact with the boundary of the range of movement of the movable unit 30a.

Further, it is explained that the inclination sensor 16 is used for specifying the inclination (holding position) of the photographing apparatus 1. However, another device may be used for specifying the inclination (holding position) of the photographing apparatus 1.

For example, the detection of the position of the movable unit 30a for the anti-shake, operation may be accomplished using the hall element etc., for specifying the inclination of the photographing apparatus 1. Specifically, the inclination (holding position) of the photographing apparatus 1 is specified based on the direction of movement of the movable unit 30a while the movable unit 30a is moved by the force of gravity under the condition where the movable unit 30a is not driven (moved).

Further, it is explained that the hall element is used for position detection as the magnetic-field change-detecting element. However, another detection element, an MI (Magnetic Impedance) sensor such as a high-frequency carrier-type magnetic-field sensor, a magnetic resonance-type magnetic-field detecting element, or an MR (Magneto-Resistance effect) element may be used for position detection purposes. When one of either the MI sensor, the magnetic resonance-type magnetic-field detecting element, or the MR element is used, the information regarding the position of the movable unit can be obtained by detecting the magnetic-field change, similar to using the hall element.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-276872 (filed on Oct. 10, 2006), which is expressly incorporated herein by reference, in its entirety.

1. A dust removal apparatus of a photographing apparatus, comprising:
a movable unit that has an imaging device and that is movable;
a detector that is used for specifying a holding position of said photographing apparatus in relationship to the direction of gravity direction; and
a controller that moves said movable unit on a plane that is parallel to a first direction and a second direction, said first direction being perpendicular to an optical axis of a photographing optical system that captures an optical image on a photographing surface of said imaging device, said second direction being perpendicular to said optical axis;
said controller striking said movable unit against a boundary of a range of movement of said movable unit in one of said first direction and said second direction, on the basis of said holding position, as a dust removal operation.

2. The dust removal apparatus according to claim 1, wherein said detector is an inclination sensor that detects an inclination of said photographing apparatus.

3. The dust removal apparatus according to claim 1, wherein said controller moves said movable unit to a predetermined position that does not make contact with said boundary of said range of movement, and strikes said movable unit against said boundary of said range of movement in one of either said first direction or said second direction under the condition where a coordinate value in the other one of said first direction and said second direction of said movable unit is held constant, as said dust removal operation.

4. The dust removal apparatus according to claim 3, wherein said predetermined position is a center of said range of movement.

5. The dust removal apparatus according to claim 1, wherein impact of said movable unit with said boundary in one of either said first direction or said second direction as said dust removal operation, are performed so that said controller moves said movable unit to strike against one side of said boundary in one of either said first direction or said second direction, against the other side of said boundary in one of either said first direction or said second direction that is the same as said direction of the previous movement, and against said one side of said boundary in one of either said first direction or said second direction that is the same as said direction of the previous movement, in order.

6. The dust removal apparatus according to claim 1, wherein said controller moves said movable unit in said range of movement for an anti-shake operation for image stabilizing; and
said dust removal operation is performed before said anti-shake operation commences.

7. The dust removal apparatus according to claim 1, wherein as said holding position of said photographing apparatus 1, one of a first horizontal position, a second horizontal position, a first vertical position, and a second vertical position is specified;
in said first horizontal position, said photographing apparatus is held in a horizontal position and an upper surface of said photographing apparatus faces upward;
in said second horizontal position, said photographing apparatus is held in said horizontal position and a lower surface of said photographing apparatus faces upward;
in said first vertical position, said photographing apparatus is held in a vertical position and a left side surface viewed from a front side of said photographing apparatus faces upward; and
in said second vertical position, said photographing apparatus is held in said vertical position and a right side surface viewed from said front side of said photographing apparatus faces upward.

8. The dust removal apparatus according to claim 7, wherein in the case that said front side or a back side of said photographing apparatus faces upward, said dust removal operation is performed as said photographing apparatus is held in one of said first horizontal position, said second horizontal position, said first vertical position, and said second vertical position.

9. The dust removal apparatus according to claim 7, wherein in said first horizontal position or said second horizontal position, said movable unit is moved and struck in said second direction; and
in said first vertical position or said second vertical position, said movable unit is moved and struck in said first direction.

10. The dust removal apparatus according to claim 1, wherein said movable unit is moved in an immediate direction in relationship to the direction of gravity direction among said first direction and said second direction corresponding to the smaller of a first angle between the direction of gravity and said first direction and a second angle between the direction of gravity and said second direction.

11. The dust removal apparatus according to claim 1, wherein said first direction is perpendicular to said second direction; and
a rectangle shape, which is a form of an imaging surface of said imaging device, has two sides that are parallel to said first direction and has two sides that are parallel to said second direction, under the condition where a control of movement of said movable unit for said dust removal operation is not performed.

12. A dust removal apparatus of a photographing apparatus, comprising:
a movable unit that has an imaging device and that is movable;
a detector that is used for specifying a holding position of said photographing apparatus in relationship to the direction of gravity direction; and
a controller that moves said movable unit on a plane;
said movable unit being moved and struck against a boundary of a range of movement of said movable unit in a smallest direction on said plane, where an angle between said smallest direction and the direction of gravity is minimized.
